(19) United States
(12) Patent Application Publication
(10) Pub. No.: US 2019/0347613 A1
(43) Pub. Date: Nov. 14, 2019

(54) LOGISTICS MANAGEMENT DEVICE, LOGISTICS MANAGEMENT METHOD, AND PROGRAM

(71) Applicants: Kabushiki Kaisha Toshiba, Minato-ku (JP); Toshiba Digital Solutions Corporation, Kawasaki-shi (JP)

(72) Inventors: Masaki SAKAI, Hino (JP); Hideki KAMEKAWA, Inagi (JP)

(73) Assignees: Kabushiki Kaisha Toshiba, Minato-ku (JP); Toshiba Digital Solutions Corporation, Kawasaki-shi (JP)

(21) Appl. No.: 16/478,715

(22) PCT Filed: Sep. 25, 2017
(86) PCT No.: PCT/JP2017/034588

§ 371 Date: Jul. 17, 2019

(30) Foreign Application Priority Data
Jan. 18, 2017 (JP) 2017-006870

(51) Int. Cl. G06Q 10/08; G01K 1/02; G01N 27/60

(52) U.S. Cl. CPC G06Q 10/0833; G06Q 10/087; G01N 27/605; G01K 1/024; G06Q 10/0832

(57) ABSTRACT

A logistics management device includes an information acquirer and an information processor. The information acquirer is configured to acquire identification information about cargo, identification information associated with a first sensor device for acquiring environmental information related to a storage location included in a section through which the cargo was transported, identification information about a second sensor device that is configured to move along with the cargo, environmental information acquired by the first sensor device, environmental information acquired by the second sensor device, and history information obtained by performing a prescribed process on the cargo. The information processor is configured to integrate the information acquired by the information acquirer and generate section environmental information indicating an environment in which the cargo was placed in the section through which the cargo was transported.

### TECHNICAL FIELD

Embodiments of the present invention relate to a logistics management device, a logistics management method, and a program.

### BACKGROUND ART

When cargo is transported to a destination, management of the quality of the cargo during transport is performed. Conventionally, when cargo is transported by truck, a device for associating and storing a temperature history and positional information of the cargo loaded within the truck and checking the temperature history of the cargo is known. However, it may not be possible to obtain information about quality management in a process of transporting cargo in conventional technology.

### CITATION LIST

### Patent Literature

[Patent Document 1]

Japanese Unexamined Patent Application, First Publication No. 2002-39659 [Suimnary of Invention]

### Technical Problem

An objective of the present invention is to provide a logistics management device, a logistics management method, and a program capable of continuously monitoring an environment in which cargo is placed in a transport process.

### Solution to Problem

A logistics management device according to an embodiment has an information acquirer and an information processor. The information acquirer acquires identification information about cargo, identification information associated with a first sensor device for acquiring environmental information related to a storage location included in a section through which the cargo was transported, identification information about a second sensor device that is configured to move along with the cargo, environmental information acquired by the first sensor device, environmental information acquired by the second sensor device, and history information obtained by performing a prescribed process on the cargo. The information processor integrates the information acquired by the information acquirer and generates section environmental information indicating an environment in which the cargo was placed in the section through which the cargo was transported.

### BRIEF DESCRIPTION OF DRAWINGS

FIG. 1 is a functional configuration diagram of a logistics system 1 including a logistics management device 60.

FIG. 2 is a diagram showing a functional configuration of the logistics management device 60.

FIG. 3 is a diagram showing an example of environmental information 82 acquired by a second information manager 64.

FIG. 4 is a diagram showing an example of a management table 84A.

FIG. 5 is a conceptual diagram of a data structure of storage/retrieval information 80.

FIG. 6 is a diagram showing a processing step performed by the logistics system 1, a cooperating system, and a type of processing.

FIG. 7 is a diagram showing an example of retrieval information included in the storage/retrieval information 80.

FIG. 8 is a diagram showing an example of storage information included in the storage/retrieval information 80.

FIG. 9 is a flowchart (1) showing a flow of a process executed by the information processor 66.

FIG. 10 is a diagram showing an example of search information.

FIG. 11 is a diagram showing an example of a matching list L1.

FIG. 12 is a diagram showing an example of information used for searching.

FIG. 13 is a diagram showing an example of a matching list L2 generated in step S118.

FIG. 14 is a flowchart (2) showing a flow of a process executed by the information processor 66.

FIG. 15 is a diagram showing an example of a generated list LC generated by integrating matching lists.

FIG. 16 is a diagram showing an example of a method of drawing a graph of a section of a p^{th} OUT-IN combination.

FIG. 17 is a diagram showing an example of an image IM displayed on a display device.

FIG. 18 is a diagram showing an example of a score table 84C.

FIG. 19 is a diagram showing an example of a mode setting table 84B stored in management information 84.

FIG. 20 is a flowchart of a modified example of a process executed by the information processor 66.

FIG. 21 is a diagram showing an example of retrospective search information.

FIG. 22 is a diagram showing an example of information acquired on the basis of the retrospective search information.

FIG. 23 is a flowchart showing an example of a flow of a process in an operation stage.

FIG. 24 is a diagram showing an example of an image IM1 including a determination result of a determiner 70.

FIG. 25 is a diagram showing an example of a scene to which the logistics system 1 of the present embodiment is applied.

### DESCRIPTION OF EMBODIMENTS

Hereinafter, a logistics management device, a logistics management method, and a program of the embodiment will be described with reference to the drawings.

### [Configuration of Logistics System]

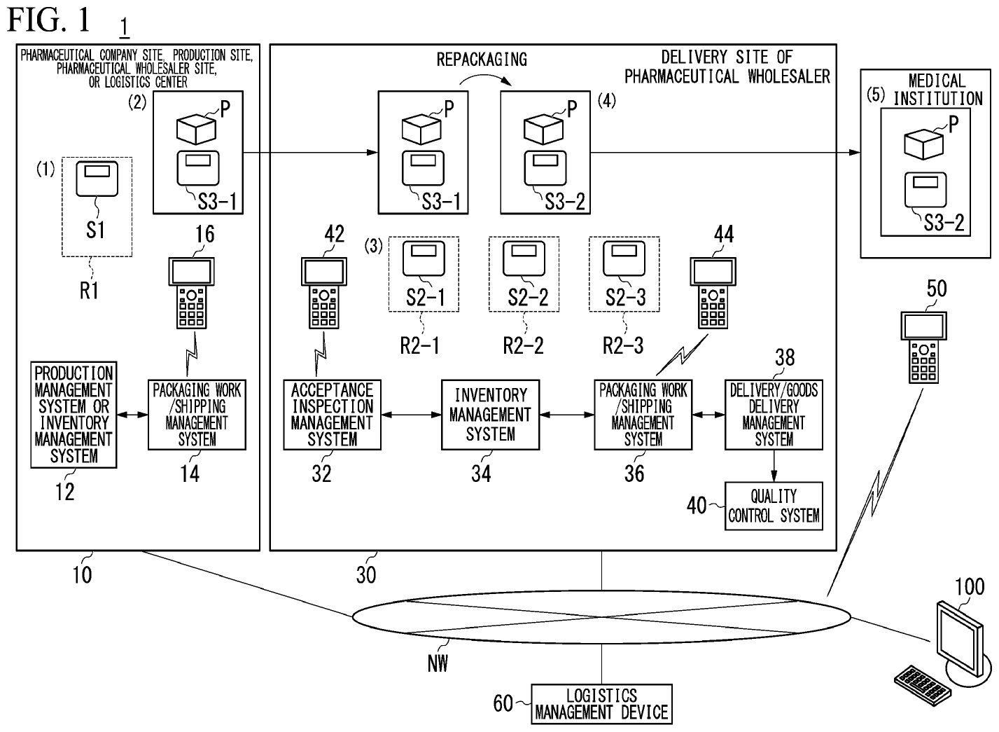

FIG. 1 is a functional configuration diagram of the logistics system 1 including the logistics management device 60. The logistics system 1 includes, for example, a production site of a pharmaceutical company or a production site or a logistics center system 10 provided in a logistics center of a pharmaceutical wholesaler, a delivery site system 30 provided in a delivery site of the pharmaceutical wholesaler, and a handy terminal 50 for a delivery clerk, a logistics management device 60, a manager terminal device 100, and sensors S3-1 and S3-2. These systems communicate with each other via a network NW such as a local area network (LAN), a wide area network (WAN), a portable phone network, a Wi-Fi network, and the Internet.

The production site or the logistics center system 10 includes, for example, a production management system or inventory management system 12, a packaging work/shipping management system 14, a handy terminal 16, and a sensor S1. The production management system or inventory management system 12 manages types of cargo managed in the logistics center, the number of cargo items, and the like. The packaging work/shipping management system 14 acquires information transmitted according to wireless communication from the handy terminal 16 and manages the acquired information. Details of the information transmitted from the handy terminal 16 will be described below.

The handy terminal 16 is a terminal device used by a worker of the logistics center. The handy terminal 16 has a built-in camera and captures an image including a label attached to cargo and information written on the cargo according to an operation of an operator. The handy terminal 16 decodes the captured image to acquire information encoded in the image. The handy terminal 16 includes, for example, a wireless communicator (not shown), and transmits information acquired from the image to the packaging work/shipping management system 14 by accessing a network according to wireless communication. The handy terminal 16 includes operation buttons for receiving an operation of the operator. When the handy terminal 16 has received an operation on an operation button of the operator, the handy terminal 16 executes various types of processing according to the operation of the operator. The various types of processing include transmitting information identified by the operation of the operator to the packaging work/shipping management system 14.

The logistics system 1 may include an input device such as a scanner instead of (or in addition to) the handy terminal 16. The scanner is a device configured to read information encoded in a barcode or the like printed on cargo. The logistics system 1 may include a tag reader configured to communicate with a communicator included in a tag and acquire information stored in an IC chip when the cargo is provided with a tag including an IC chip such as a radio frequency identifier (RFID) tag.

The sensor S1 is, for example, a sensor provided in a room (an example of a storage location) in which the cargo of the logistics center is stored, and is a sensor configured to detect a temperature, a humidity, and the like in the room. The sensor S1 transmits the detected temperature to the logistics management device 60 at prescribed intervals via the network NW.

The delivery site system 30 includes, for example, an acceptance inspection management system 32, an inventory management system 34, a packaging work/shipping management system 36, a delivery/goods delivery management system 38, a quality management system 40, a handy terminal 42, a handy terminal 44, and sensors S2-1 to S2-3.

The acceptance inspection management system 32 acquires information transmitted by wireless communication from the handy terminal 42 and manages the acquired information. Details of the information transmitted from the handy terminal 42 will be described below.

The inventory management system 34 manages types of cargo managed at a delivery site, the number of cargo items, and the like. The packaging work/shipping management system 36 acquires information transmitted by wireless communication from the handy terminal 44 and manages the acquired information. Details of the information acquired from the handy terminal 44 will be described below.

The delivery/goods delivery management system 38 manages a delivery situation or a goods delivery situation of the cargo. The quality management system 40 manages information indicating the quality of the cargo after the cargo is delivered to a delivery destination in association with identification information about the cargo. The information indicating the quality of the cargo may be information derived by the processing of the logistics management device 60 or may indicate the quality (a result of a pharmaceutical efficacy check or the like) recognized at the delivery destination after the cargo is delivered to the delivery destination.

Functional configurations of the handy terminal 42 and the handy terminal 44 are similar to the functional configuration of the handy terminal 16 described above and therefore a description thereof will be omitted.

The sensors S2-1 to S2-3 are, for example, sensors provided respectively in rooms 1 to 3 in which the cargo of the delivery site is stored and configured to detect a temperature, a humidity, and the like within the rooms. The sensors S2-1 to S2-3 transmit the detected temperature, humidity, and the like to the logistics management device 60 at prescribed intervals via a network such as a LAN. Hereinafter, the sensor S1 and the sensors S2-1 to S2-3 described above will be simply referred to as “first sensor devices” unless special distinction is made. The first sensor device is a sensor device configured to acquire environmental information of a storage location included in a section through which the cargo was transported. In the description of the logistics management device 60 to be described below and the like, the storage location of the cargo may be referred to as a “storage space”. An operation or process of putting cargo in the storage space may be referred to as “storage”, and an operation or process of taking out the cargo from the storage space may be referred to as “retrieval”. The storage location of the cargo or the “storage space” does not necessarily have to be a room of real estate such as a building, and may be a cargo compartment of a truck, a ship, or an aircraft for temporarily storing the cargo.

The handy terminal 50 for the delivery clerk is, for example, a terminal device to be used by the delivery clerk who delivers cargo from a delivery site to a medical institution of a delivery destination. After the delivery clerk delivers the cargo to the delivery destination, the delivery clerk performs a prescribed operation on the handy terminal 50 in order that the delivery clerk transmits information indicating that the cargo has been delivered to the delivery destination to the logistics management device 60 via the network NW. The functional configuration of the handy terminal 50 for the delivery clerk is similar to the functional configuration of the handy terminal 16 and therefore a description thereof will be omitted. The handy terminal 50 for the delivery clerk can be replaced with, for example, a computer terminal provided at a delivery site of a pharmaceutical wholesaler. That is, the information indicating that the cargo has been delivered to the delivery destination or the like may be read from a sales slip or the like after delivery, input to the computer terminal by a worker, and transmitted to the logistics management device 60 via the network NW.

In the logistics system 1, for example, a sensor S3-1 and a sensor S3-2 are used. Hereinafter, when the sensors S3-1 and S3-2 are not distinguished from each other, they are simply referred to as “second sensor devices”. The second sensor device is a sensor configured to move along with the delivered cargo and, for example, is attached to the cargo or provided in a box or the like for storing the cargo when the cargo is transported. When the sensor device is attached to the cargo or when the sensor device is provided in the box or the like for storing the cargo when the cargo is transported, this state may be hereinafter referred to as a “bundled” state. The second sensor device detects, for example, an ambient temperature, humidity, acceleration, and the like. The second sensor device includes a communication interface configured to communicate with a portable terminal and an access point for connecting to the network NW and transmits detection results to the logistics management device 60 via the network NW. Hereinafter, detection results of the first sensor device and the second sensor device will be referred to as “environmental information”. The first sensor device or the second sensor device may have a function of detecting light, atmospheric pressure, and the like in addition to temperature, humidity, and the like. The number of first sensor devices and the number of second sensor devices are merely an example, and the logistics system 1 may have any number of first sensor devices and any number of second sensor devices.

[Outline when Cargo is Transported to Delivery Destination]

An outline until cargo P is delivered to a medical institution that is a delivery destination after the cargo P is delivered to a logistics center will be described. Details of this information will be described below.

(1) For example, when the cargo P is produced by a pharmaceutical company or delivered to a logistics center, the cargo P is stored in a room provided with the sensor S1. Then, information indicating that the cargo P is stored in the room R1 in which the sensor S1 is provided is transmitted to the logistics management device 60. A detection result of the sensor S1 is transmitted to the logistics management device 60 on a daily basis. The information indicating that the cargo P is being stored in the room in which the sensor S1 is provided is acquired by, for example, the handy terminal 16.

(2) Next, in the pharmaceutical company site, the production site, the pharmaceutical wholesaler site or the logistics center, for example, the sensor S3-1 is attached to the cargo P and the cargo P is transported to the delivery site along with the sensor S3-1. Then, information indicating that the cargo P has left the room R1 and has been transported to the delivery site is transmitted to the logistics management device 60. Information indicating that the cargo P has left the room R1 is acquired by, for example, the handy terminal 16. The detection result of the sensor S3-1 may be transmitted to the logistics management device 60 after the cargo P is taken into the room for storing the cargo at the delivery site of the pharmaceutical wholesaler and the sensor S3-1 is removed. Alternatively, detection results of the sensor S3-1 so far may be transmitted to the logistics management device 60 at intervals whilst on the way in the transport section until the cargo P is taken into a room R2-1 of the delivery site of the pharmaceutical wholesaler.

(3) Next, at the delivery site, the cargo P is stored, for example, in the room R2-1 provided with the sensor S2-1. Then, information indicating that the cargo P has been stored in the room R2-1 provided with the sensor S2-1 is transmitted to the logistics management device 60. A detection result of the sensor S2-1 is transmitted to the logistics management device 60 on a daily basis. The information indicating that the sensor S2-1 has been stored in the room is acquired by, for example, the handy terminal 42. Then, before the following processing of (4) is performed, the sensor 3′ is removed by the worker in the room R2-1.

(4) Next, while the cargo P is being moved from the room R2-1 to a room R2-2, the cargo P is newly packaged along with other cargo and the sensor S3-2 is attached to the packaged material or cargo P. The cargo P is further moved to a room R2-3 along with the other cargo and the sensor S3-2 and is delivered to the destination medical institution. Information indicating that the cargo P has been repackaged at the delivery site, information indicating that the cargo P has been moved from the room, and information indicating that the cargo P has been delivered from the room are transmitted to the logistics management device 60. The information indicating that the cargo P has been repackaged, the information indicating that the cargo P has been moved from the room, and the information indicating that the cargo P has been delivered from the room are acquired by, for example, the handy terminal 44. A detection result of the sensor S3-2 may be transmitted to the logistics management device 60 after the cargo P is taken into the delivery destination medical institution and the sensor S3-2 is removed. Alternatively, detection results of the sensor 3-2 so far may be transmitted to the logistics management device 60 at intervals whilst on the way in the transport section until the cargo P is taken into the delivery destination medical institution.

(5) Next, the cargo P is delivered from the delivery site to the medical institution of the destination. Then, the detection result of the sensor S3-2 in the medical institution, the detection result of the sensor S3-2 at the goods delivery time, and the information indicating that the cargo P has been delivered to the medical institution are transmitted from the delivery site to the physical logistics management device 60. The information indicating that the cargo P has been delivered to the medical institution is acquired by, for example, the handy terminal 50 for the delivery clerk.

### [Logistics Management Device]

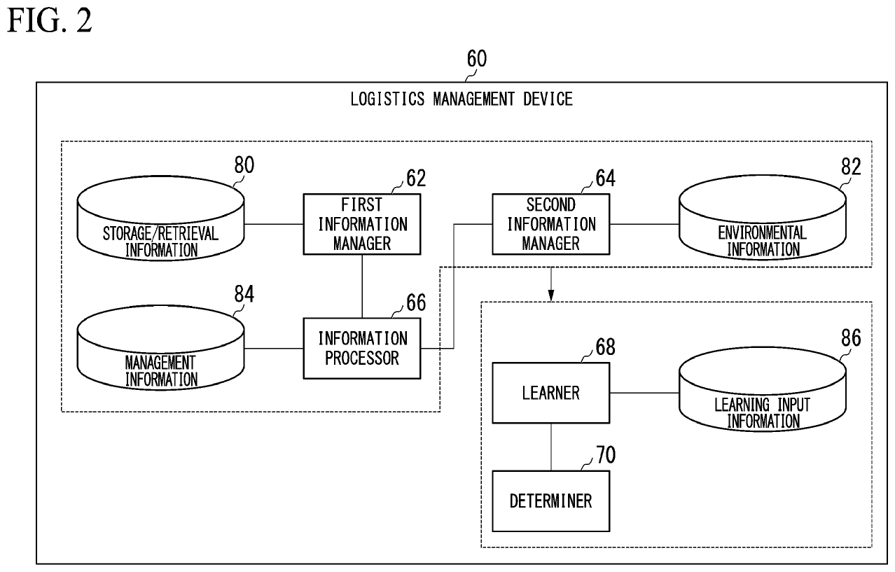

FIG. 2 is a diagram showing a functional configuration of the logistics management device 60. For example, the logistics management device 60 includes a first information manager (first information acquirer) 62, a second information manager (second information acquirer) 64, an information processor 66, a learner 68, a determiner 70, storage/retrieval information (history information) 80, environmental information 82, management information 84, and learning input information 86. These functional units may be distributed to a plurality of devices. The first information manager 62 and the second information manager 64 are examples of an “information acquirer”.

The first information manager 62, the second information manager 64, the information processor 66, the learner 68, and the determiner 70 may be implemented when a processor such as a central processor (CPU) executes a program stored in a storage device provided in the logistics management device 60. All or some of these functional units are implemented by hardware such as large scale integration (LSI), an application specific integrated circuit (ASIC), or a field-programmable gate array (FPGA) and may have a circuit component for implementing the functions of these functional units. These functional units may be implemented by cooperation of software and hardware. The storage/retrieval information 80, the environmental information 82, the management information 84, and the learning input information 86 are stored in the storage device implemented by, for example, a non-volatile storage medium such as a read only memory (ROM), a flash memory, or a hard disk drive (HDD) and a volatile storage medium such as a random access memory (RAM) or a register.

The first information manager 62 acquires identification information about cargo, identification information associated with the first sensor device, identification information about the second sensor device, and history information obtained by performing a prescribed process on the cargo. The identification information associated with the first sensor device may be identification information about the first sensor device or may be identification information about a communicator (for example, an access point) configured to acquire information of the first sensor device and transmit the acquired information to the first information manager 62. When the identification information associated with the first sensor device is the identification information about the communicator, the first information manager 62 identifies the identification information about the first sensor device on the basis of a associating relationship between the identification information about the first sensor device pre-stored in the storage of the logistics management device 60 and the identification information about the communicator. The first information manager 62 manages the acquired information as the storage/retrieval information 80 (details thereof will be described below). The storage/retrieval information 80 is, for example, information about storage or retrieval of the cargo acquired by the handy terminal 16, 42, or 44 or the handy terminal 50 for the delivery clerk. The first information manager 62 and the storage/retrieval information 80 are, for example, a relational database management system including a relational database.

The second information manager 64 acquires environmental information acquired by the first sensor device and environmental information acquired by the second sensor device, and manages the acquired information as the environmental information 82 (details thereof will be described below). The environmental information 82 is, for example, information about a space in which the cargo is present acquired by the first sensor device and the second sensor device. The second information manager 64 and the environmental information 82 are, for example, a NoSQL type database management system including a NoSQL type database.

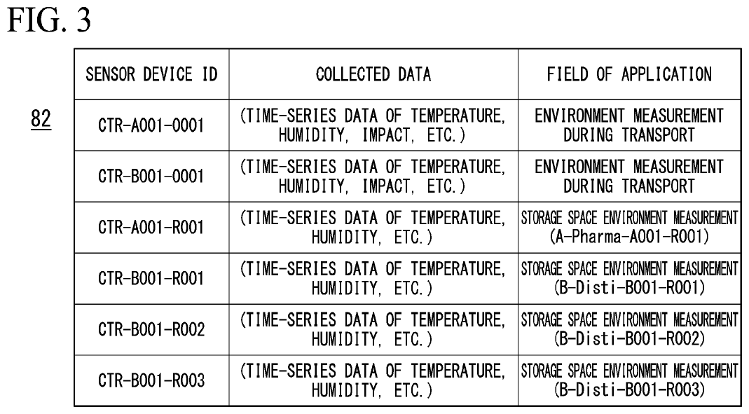

FIG. 3 is a diagram showing an example of the environmental information 82 acquired by the second information manager 64. In the environmental information 82, information such as data collected by the sensor device, a field of application of the sensor device, and an installation location (for example, a room) is stored in association with a sensor device ID. The sensor devices include, for example, second sensor devices (CTR-A001-0001 and CTR-B001-0001 to be described below) and first sensor devices (CTR-A001-R001, CTR-B001-R001, CTR-B001-R002, and CTR-B001-R003 to be described below).

For example, it is possible to efficiently search for information related to retrieval and storage of cargo using the relational database management system and to efficiently store a detection result of the sensor having a large amount of data and efficiently extract the detection result of the sensor using the NoSQL type database management system. For example, because information about the retrieval and storage of the cargo is not mixed with the detection result of the sensor in the database, the searching and extraction of the information are easy as compared with when the information is mixed therewith in the database.

In the logistics management device 60, the first information manager 62, the storage/retrieval information 80, the second information manager 64, and the environmental information 82 may be formed as one data management system. The storage/retrieval information 80, the environmental information 82, the management information 84, and the learning input information 86 may be stored in a single storage device or may be distributed and stored in a plurality of storage devices.

The information processor 66 integrates the information acquired by the first information manager 62 and the second information manager 64, and generates section environmental information indicating an environment in which the cargo was placed in the section through which the cargo was transported. The section environmental information is information in which a clock time at which the cargo was transported or a section through which the cargo was transported, identification information about the cargo, and environmental information are associated. The information processor 66 causes the generated information to be displayed on display devices of the packaging work/shipping management systems 14 and 36, the handy terminals 16, 42, and 44, the handy terminal 50 for the delivery clerk, the delivery/goods delivery management system 38, the manager terminal device 100, and the like. The information processor 66 may transmit the generated information to a system (not shown) of the delivery destination medical institution.

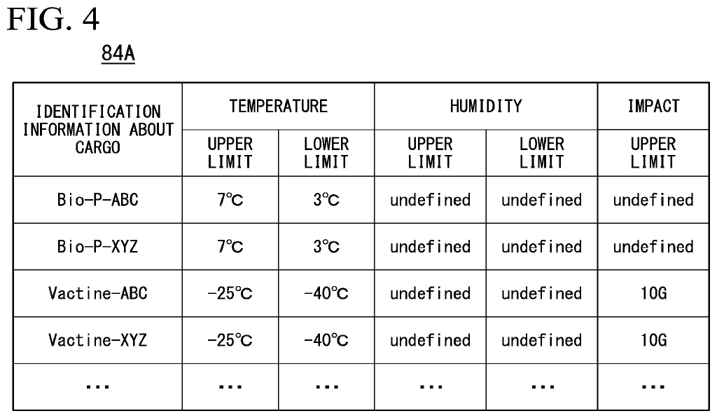

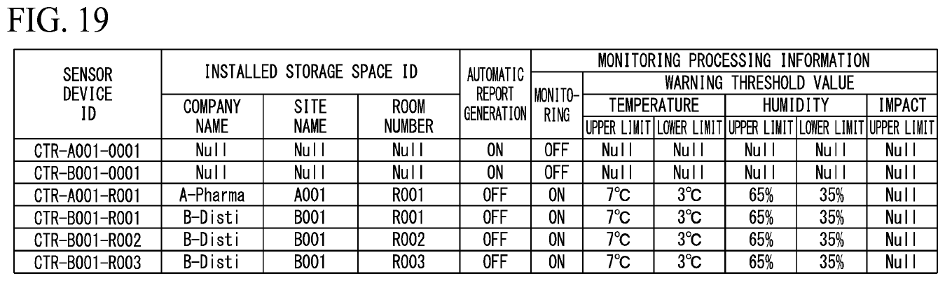

The management information 84 stores a management table 84A and a mode setting table 84B. The management table 84A is information in which identification information (for example, a product name or the like) about cargo is associated with a standard relative to environmental information. The standard relative to the environmental information is, for example, a standard value of an allowable (or suitable) environment of a space where the cargo is placed when the cargo is stored or delivered. FIG. 4 is a diagram showing an example of the management table 84A. For example, as shown, the management table 84A stores upper and lower limits of the temperature, upper and lower limits of the humidity, and an upper limit value of a magnitude of the impact to which the cargo is subjected in the space where the cargo is placed. Details of the mode setting table 84B will be described below (see FIG. 19).

The learner 68 learns a relationship between the section environmental information generated by the information processor 66, the preset standard, and the quality of the cargo when the cargo has arrived at the destination. The learning input information 86 is information used by the learner 68 and includes information in which the section environmental information generated by the information processor 66 and the quality of the cargo when the cargo has arrived at the destination are associated with the identification information about the cargo. The determiner 70 determines whether or not it is possible to maintain the quality at a set standard or more until the transport of the cargo which is being transported is completed on the basis of a learning result from the learner 68 and the information acquired by the first information manager 62 and the second information manager 64.

### [Outline of Storage/Retrieval Information]

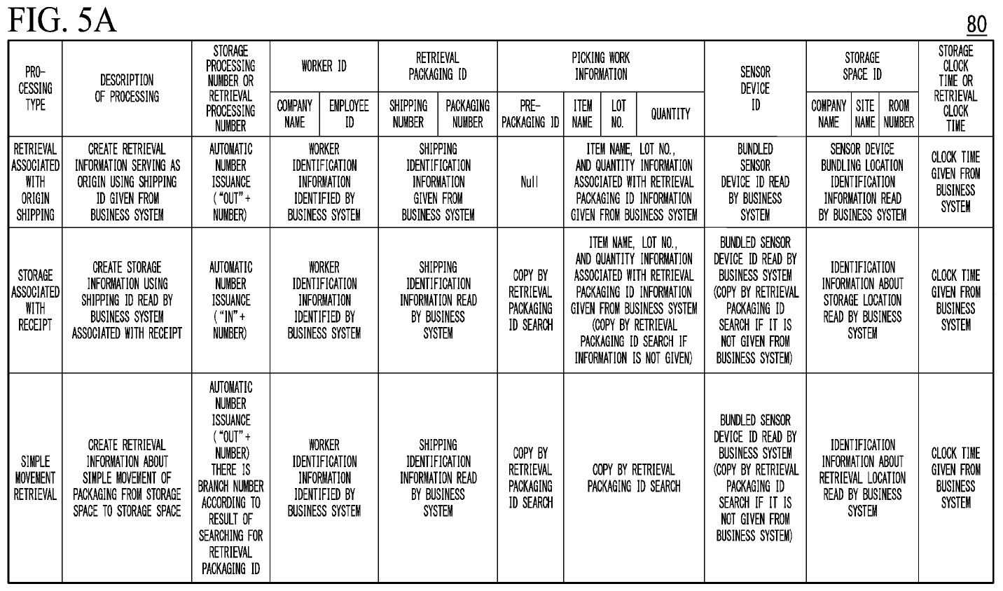

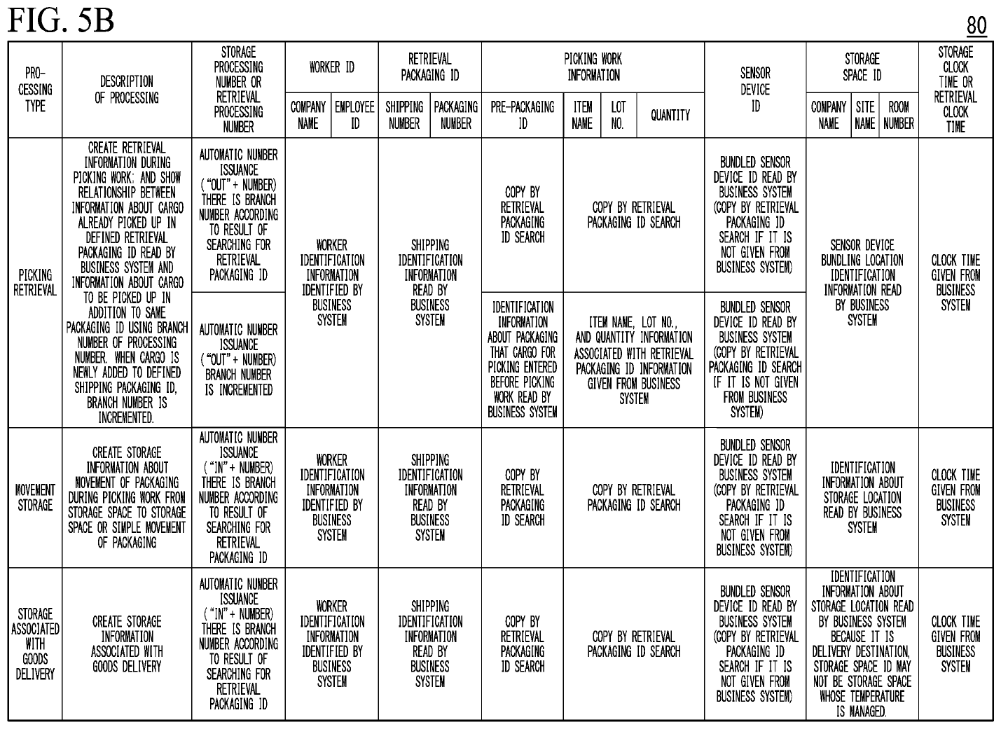

First, a data structure of the storage/retrieval information 80 will be described. FIG. 5 is a conceptual diagram of the data structure of the storage/retrieval information 80. The storage/retrieval information 80 is information in which a processing number (a storage processing number or a retrieval processing number), a worker ID (a company name and a worker ID), a retrieval packaging ID (a shipping number and a packaging number), picking work information (a pre-packaging ID, an item name, a lot No., and a quantity), a sensor device ID, a storage space ID (a company name, a site name, and a room number), and a clock time (a storage clock time or a retrieval clock time) are associated with a processing type. In the storage/retrieval information 80, information processed at the time of storage is storage information and information processed at the time of retrieval is retrieval information. Also, information associated with the processing number, the worker . . . , the clock time described above may be referred to as an information ID. Also, the packaging work/shipping management system or the acceptance inspection management system will be described as a business system in FIG. 5.

The processing type is, for example, retrieval associated with origin shipping, storage associated with receipt, simple movement retrieval, picking retrieval, movement storage, and storage associated with goods delivery. Hereinafter, an outline of processes and data during the processes will be described.

The “retrieval associated with origin shipping” is a process of generating retrieval information serving as a base point on the basis of, for example, a shipping ID given by the packaging work/shipping management system provided at the origin of product shipping. The retrieval processing number is automatically issued (OUT+number). The worker ID is a worker ID identified by the packaging work/shipping management system. Because the worker ID is similarly identified in the other processing types, the description of the worker ID will be omitted in the description of the other processing types. The retrieval packaging ID is shipping identification information given by the packaging work/shipping management system.

The pre-packaging ID of the picking work information is set to “Null”, and the item name, the lot No., and the quantity correspond to a retrieval packaging ID information given by the packaging work/shipping management system. The sensor device ID is a bundled sensor device ID read by the packaging work/shipping management system. The bundled sensor device is a sensor device included in the second sensor device. The storage space ID is identification information about a room provided with a sensor device of the sensor device ID read by the packaging work/shipping management system. The clock time is a clock time given by the packaging work/shipping management system. Alternatively, it may be decided to use the clock time of the logistics management device 60. The clock time is identified in a similar manner in the other processing types and therefore the description of the clock time will be omitted in the description of the other processing types.

The “storage associated with receipt” is, for example, a process of generating storage information on the basis of a shipping packaging ID read by the acceptance inspection management system associated with the receipt. The storage processing number is automatically issued (IN+number). The retrieval packaging ID is shipping packaging identification information read by the packaging work/shipping management system. Because the retrieval packaging ID is similarly identified from the information read by the acceptance inspection management system or the packaging work/shipping management system in the processing type to be described below, a description thereof will be omitted in the description of the processing type to be described below.

The pre-packaging ID of the picking work information is searched for from the storage/retrieval information 80 by the logistics management device 60 and a search result is copied (hereinafter referred to as a “copy process”). Specifically, the logistics management device 60 copies data of the same attributes from the latest information ID obtained by searching for the storage/retrieval information 80 using the retrieval packaging ID. When the latest information ID obtained by searching for the storage/retrieval information 80 using the retrieval packaging ID has information IDs of a plurality of branch numbers, an information ID of a copy destination also has an information ID structure with a plurality of branch numbers. The item name, the lot No., and the quantity relative to the retrieval packaging ID are an item name, a lot No., and a quantity relative to the retrieval packaging ID given from the acceptance inspection management system. When such information is not given, the copy process is performed.

The sensor device ID is a sensor device ID of the bundled sensor device read by the packaging work/shipping management system. When the sensor device ID is not given from the packaging work/shipping management system, the copy process is performed. The storage space ID is identification information about a storage location of cargo read by the packaging work/shipping management system. The clock time is a clock time given by the packaging work/shipping management system. Alternatively, it may be decided to use the clock time of the logistics management device 60.

The “simple movement retrieval” is, for example, a process of generating retrieval information about the simple movement of a packaged cargo from the storage space to the storage space. The retrieval processing number is automatically issued (OUT+number). At this time, a branch number is present according to a search result of the retrieval packaging ID. Specifically, when the latest information ID obtained by searching for the storage/retrieval information 80 using the retrieval packaging ID has information IDs of a plurality of branch numbers, the information ID of the copy destination has also an information ID structure with a plurality of branch numbers. The retrieval packaging ID is shipping identification information read by the packaging work/shipping management system.

The pre-packaging ID of the picking work information is searched for from the storage/retrieval information 80 by the logistics management device 60 and a search result is copied. Specifically, the logistics management device 60 copies data of the same attribute from the latest information ID obtained by searching for the storage/retrieval information 80 using the retrieval packaging ID. When the latest information ID obtained by searching for the storage/retrieval information 80 using the retrieval packaging ID has information IDs of a plurality of branch numbers, the information ID of the copy destination also has an information ID structure with a plurality of branch numbers. The item name, the lot No., and the quantity relative to the retrieval packaging ID are an item name, a lot No., and a quantity relative to the retrieval packaging ID given from the packaging work/shipping management system. When such information is not given, a copy process is performed.

The sensor device ID is a sensor device ID of the bundled sensor device read by the packaging work/shipping management system. When the sensor device ID is not given from the packaging work/shipping management system, the copy process is performed. The storage space ID is identification information about a retrieval location of the cargo read by the packaging work/shipping management system.

The “picking retrieval” is a process of generating retrieval information during the picking work. The packaging work/shipping management system represents a relationship between information about cargo that has already been picked up and information about cargo to be picked up in addition to the same packaging ID by assigning a branch number in a processing number to the read defined retrieval packaging ID. When a new cargo is added to the defined shipping cargo ID, the branch number is incremented.

The retrieval processing number is automatically issued (OUT+number). At this time, a branch number may be present in the retrieval processing number according to a result of a search by the retrieval packaging ID. The pre-packaging ID of picking work information is given by the copy process. Also, when cargo is newly added to the defined shipping cargo ID, the branch number is incremented in the retrieval processing number and the picking work information is added. The pre-packaging ID of the added picking work information is identification information about packaging read by the packaging work/shipping management system and is identification information about packaging that the cargo for picking entered before the picking work. The item name, the lot No., and the quantity relative to the added picking work information are an item name, a lot No., and a quantity of the added cargo given from the packaging work/shipping management system.

The sensor device ID of the picking work information to be added is a sensor device ID of a bundled sensor device read by the packaging work/shipping management system. When no sensor device ID is given from the packaging work/shipping management system, a copy process is performed from a result of a search using the retrieval packaging ID. The storage space ID is identification information about a picking retrieval location of cargo read by the packaging work/shipping management system.

The “movement storage” is, for example, a process of generating storage information about the movement of packaging during picking work from the storage space to the storage space or the simple movement of packaging. The storage processing number is automatically issued (IN+number). A branch number is present according to the result of the search using the retrieval packaging ID.

Picking work information is given from the copy process. The sensor device ID is a sensor device ID of the bundled sensor device read by the packaging work/shipping management system. When no sensor device ID is given from the packaging work/shipping management system 36, a copy process is performed. The storage space ID is identification information about a storage location of cargo read by the packaging work/shipping management system.

The “storage associated with goods delivery” is, for example, a process of generating storage information associated with goods delivery. A storage processing number, picking work information, and a sensor device ID are processed in a manner similar to that of the process of “movement storage”. A storage space ID is identification information about a storage location of cargo read by the packaging work/shipping management system. Because the storage location is a delivery destination, the storage space ID may not be a temperature-controlled storage space.

### [Specific Example of Storage/Retrieval Information]

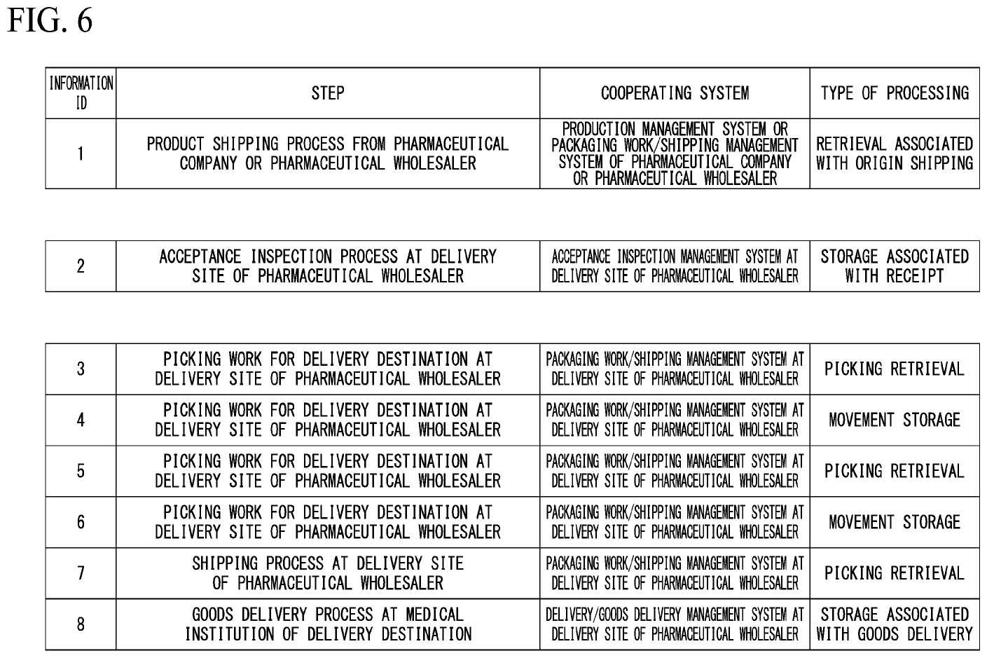

The information generated when the above-described processing of (1) to (5) of [Outline when cargo is transported to delivery destination] is performed will be described with reference to FIGS. 6 to 8. FIG. 6 is a diagram showing a processing step performed by the logistics system 1, a cooperating system, and a processing type. Information associated with one processing step, a cooperating system, and a processing type is referred to as an information ID. Information IDs 1 to 8 are shown in FIG. 6.

First, as shown in the information ID1, the step “product shipping process from a pharmaceutical company or a pharmaceutical wholesaler” is performed in cooperation by the production system of the pharmaceutical company or the pharmaceutical wholesaler or the packaging work/shipping management system 14 and is associated with the processing type “retrieval associated with origin shipping”. Next, as shown in the information ID 2, the step “acceptance inspection process at the delivery site of the pharmaceutical wholesaler” is performed in cooperation by the acceptance inspection management system 32 at the delivery site of the pharmaceutical wholesaler and is associated with the processing type “storage associated with receipt”. Next, as shown in the information ID 3, the step “picking work for the delivery destination at the delivery site of the pharmaceutical wholesaler” is performed in cooperation by the packaging work/shipping management system 36 at the delivery site of the pharmaceutical wholesaler and is associated with the processing type “picking retrieval”. The steps of the processing types “movement storage”, “picking retrieval” and “movement storage” of the information IDs 4, 5, and 6 to be described below are similar to the step “picking work for the delivery destination at the delivery site of the pharmaceutical wholesaler” of the information ID 3. In the information IDs 4 to 6, the cooperating system is also the packaging work/shipping management system 36 as in the information ID 3.

Next, as shown in the information ID 7, the step “shipping process at the delivery site of the pharmaceutical wholesaler” is performed in cooperation by the packaging work/shipping management system 36 at the delivery site of the pharmaceutical wholesaler and is associated with the processing type “picking retrieval”. Next, as shown in the information ID 8, the step “goods delivery process at the delivery destination medical institution” is performed in cooperation by the delivery/goods delivery management system 38 at the delivery site of the pharmaceutical wholesaler and is associated with the processing type “storage associated with goods delivery”.

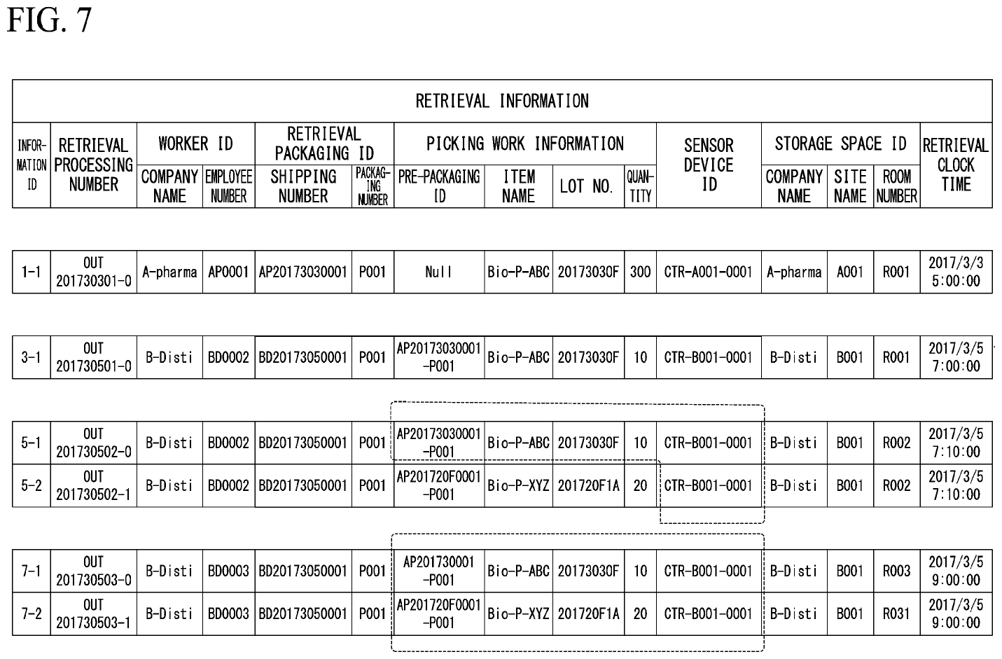

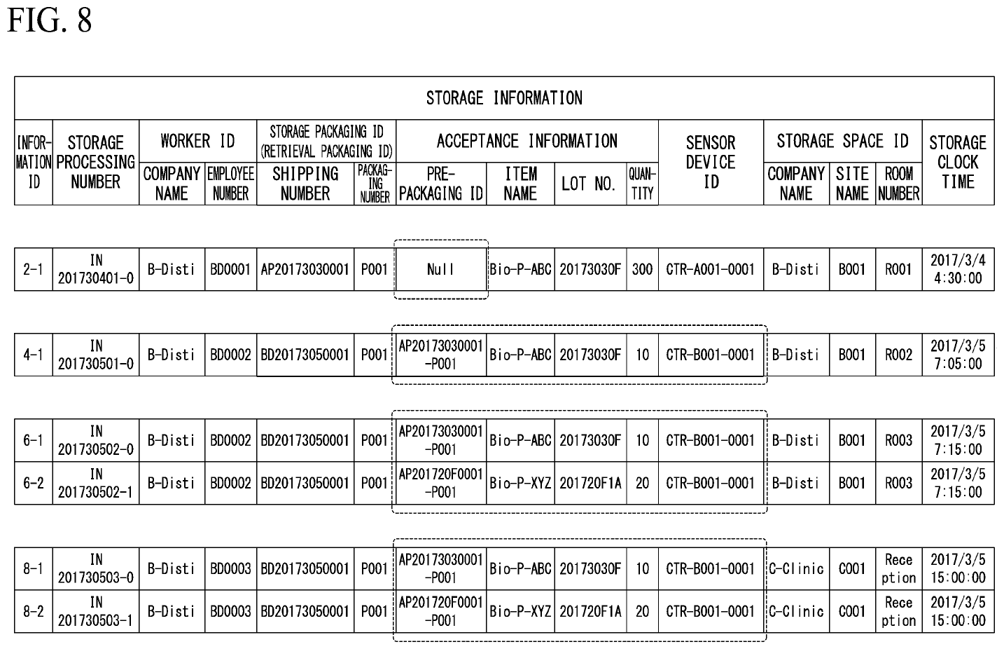

FIG. 7 is a diagram showing an example of the retrieval information included in the storage/retrieval information 80. Information IDs 1-1, 3-1, 5-1, 5-2, 7-1, and 7-2 are shown in FIG. 7. FIG. 8 is a diagram showing an example of the storage information included in the storage/retrieval information 80. Information IDs 2-1, 4-1, 6-1, 6-2, 8-1, and 8-2 are shown in FIG. 8. Information surrounded by dotted lines shown in FIGS. 7 and 8 is information already registered in the retrieval information or the storage information by the previous process in the time series. The information processor 66 copies data of the same attribute from the latest information ID obtained by searching for the storage/retrieval information 80 using the retrieval packaging ID according to the processing type. When the latest information ID obtained by searching for the storage/retrieval information 80 using the retrieval packaging ID has information IDs of a plurality of branch numbers, the information ID of the copy destination also has an information ID structure with a plurality of branch numbers. In FIG. 7 and FIG. 8, the information copied in this manner is shown surrounded by dotted lines. Information different from the information surrounded by dotted lines shown in FIGS. 7 and 8 may also be copied.

In the following description, a description will be given using the identification numbers of the information IDs in FIGS. 7 and 8 in a state in which drawing numbers are omitted. The order of generation of the information described below is merely an example and any order may be used.

First, the “retrieval associated with origin shipping” will be described. First, information shown in the information ID 1-1 is generated. The information ID 1-1 is information indicating that the second sensor device “CTR-A001-0001” is bundled with cargo and retrieval from a “room R001 of a site A001 of A-Pharma company” at a clock time “2017/3/3 5:00” was performed.

Next, the “storage associated with receipt” is performed and information shown in the information ID 2-1 is generated. The information ID 2-1 is information indicating that 300 cargo items with which the second sensor device “CTR-A001-0001” is bundled was stored in a “room R001 of a site B001 of a B-Disti pharmaceutical wholesaler” in which the first sensor device “CTR-B001-R001” is provided at a clock time “2017/3/4 4:30”. Although a pre-packaging ID within the information ID 2-1 was not acquired from the packaging work/shipping management system 36, the pre-packaging ID is copied from the information ID 1-1 using a storage packaging ID (assumed to indicate the same information as a retrieval packaging ID in retrieval) as a key.

Next, the “picking retrieval” is performed and the information ID 3-1 is generated. The information ID 3-1 is information indicating that ten cargo items were picked, the second sensor device “CTR-B001-0001” was bundled with the cargo items, and the cargo items were retrieved from “Room R001 of Site B001 of the B-Disti pharmaceutical wholesaler at a clock time “2017/3/5 7:00”. At this time, although the second sensor device “CTR-A001-0001” has already been removed from the stored cargo after the storage process associated with the information ID 2-1, the second sensor device “CTR-A001-0001” remains bundled with the cargo before the picking and is not bundled with the cargo after the picking. The retrieval packaging ID acquired at this time is a newly assigned ID different from the information ID 2-1.

Next, the “movement storage” is performed and the information ID 4-1 is generated. The information ID 4-1 is information indicating that ten cargo items were stored in a room R002 of the site B001 of the B-Disti pharmaceutical wholesaler in which the first sensor device “CTR-B001-R002” is provided at a clock time “2017/3/5 7:05”. Although the acceptance information and the sensor device ID within the information ID 4-1 are not acquired from the packaging work/shipping management system 36, the acceptance information and the sensor device ID are copied from the information ID 3-1 using the storage packaging ID (assumed to indicate the same information as the retrieval packaging ID in the retrieval) as a key.

Next, the “picking retrieval” is performed and the information IDs 5-1 and 5-2 are generated. The information IDs 5-1 and 5-2 are information indicating that cargo items “Item name: Bio-P-XYZ and quantity of 20 items” stored in the “room R002 of the site B001 of the B-Disti pharmaceutical wholesaler” were retrieved after addition to the retrieval packaging ID “BD20173050001-P001” through a prescribed step. This information is information indicating that cargo items “Item name: Bio-P-ABC and 10 items” handled in the above-described information ID, newly handled cargo items “Item name: Bio-P-XYZ and 20 items”, and the second sensor device “CTR-B001-0001” are bundled and the cargo items were retrieved from the “room R002 of the site B001 of B-Disti Pharmaceutical wholesale” at a clock time “2017/3/5 7:10”. Although picking information and a sensor device ID within the information ID 5-1 are not acquired from the packaging work/shipping management system 36, the latest storage/retrieval information 80 is searched for and identified using the retrieval packaging ID as a key and the same attribute is copied. In order to acquire a transport environment of the added item name “Bio-P-XYZ” in the information ID 5-2, a sensor device that is the same as a sensor device bundled to acquire a transport environment of an item name “Bio-P-ABC” associated with the retrieval packaging ID before the cargo is added is used. Therefore, because it is not necessary to add a new sensor device in the information ID 5-2, there is no acquisition of a new sensor device ID from the packaging work/shipping management system 36 and the sensor device ID information is copied from the storage/retrieval information identified by searching for the latest storage/retrieval information 80 using the retrieval packaging ID.

Next, the “movement storage” is performed and the information IDs 6-1 and 6-2 are generated. The information IDs 6-1 and 6-2 are information indicating that cargo subjected to picking retrieval was stored in a room R003 of the site B001 of the B-Disti pharmaceutical wholesaler provided with the first sensor device “CTR-B001-R003” at a clock time “2017/3/5 7:15”. Although the acceptance information and the sensor device ID within the information IDs 6-1 and 6-2 are not acquired from the packaging work/shipping management system 36, the latest storage/retrieval information 80 is searched for and identified using the storage packaging ID (assumed to indicate the same information as the retrieval packaging ID in the retrieval) as a key and the same attribute is copied.

Next, the “picking retrieval” is performed and the information IDs 7-1 and 7-2 are generated. The information IDs 7-1 and 7-2 are information indicating that a shipping process is performed at the delivery site of the pharmaceutical wholesaler after cargo stored in the “room R003 of the site B001 of the B-Disti pharmaceutical wholesaler” is stored during a prescribed period. This information is information indicating that the cargo was retrieved from the “room R003 of the site B001 of the B-Disti pharmaceutical wholesaler” at a clock time “2017/3/5 9:00”. Although picking information and a sensor device ID within the information IDs 7-1 and 7-2 were not acquired from the packaging work/shipping management system 36, the latest storage/retrieval information 80 is searched for and identified using the retrieval packaging ID as a key and the same attribute is copied.

Next, the “storage associated with goods delivery” is performed and the information IDs 8-1 and 8-2 are generated. The storage process associated with the goods delivery is performed and the information IDs 8-1 and 8-2 are storage information relative to the storage process associated with the goods delivery. This information is information indicating that cargo retrieved from the delivery site of the pharmaceutical wholesaler was delivered to “Reception of a C-Clinic site C001” which is a delivery destination at a clock time “2017/3/5 15:00”. Although the acceptance information and the sensor device ID within the information IDs 8-1 and 8-2 are not acquired from the packaging work/shipping management system 36, the latest storage/retrieval information 80 is searched for and identified using the storage packaging ID (assumed to indicate the same information as the retrieval packaging ID in the retrieval) as a key and the same attribute is copied.

As described above, the first information manager 62 acquires information about storage and retrieval of cargo and manages the acquired information as the storage/retrieval information 80.

### [Process of Information Processor]

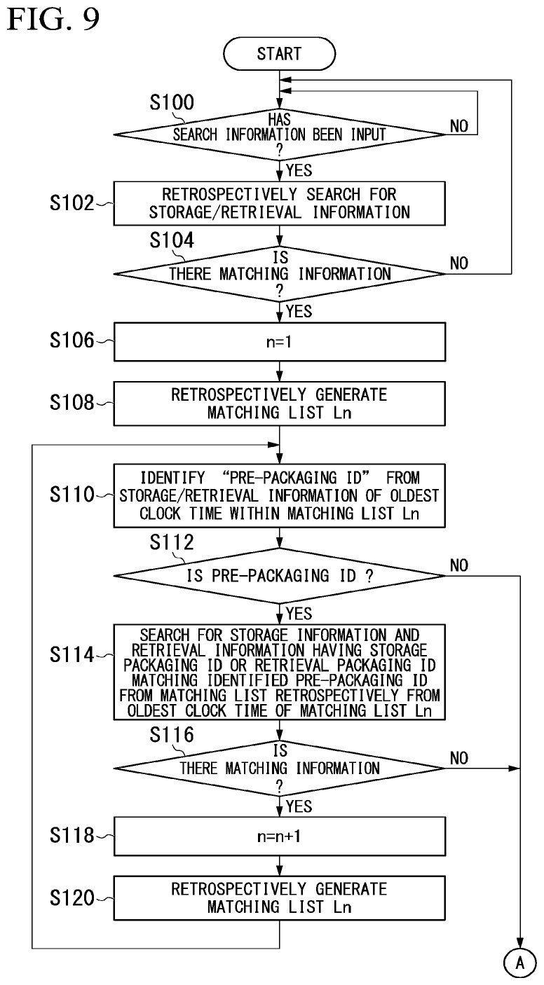

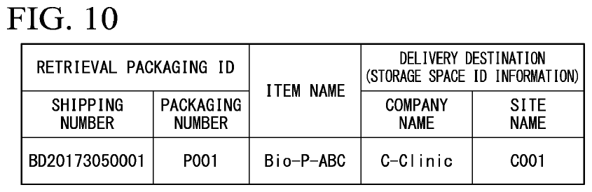

FIG. 9 is a flowchart (1) showing a flow of a process executed by the information processor 66. First, the information processor 66 waits for search information to be input by a user or the like (step S100). FIG. 10 is a diagram showing an example of search information. The search information includes, for example, information about a retrieval packaging ID, an item name, and a delivery destination (or a storage space ID). In the example shown in FIG. 10, the storage/retrieval information 80 is searched for on the basis of AND matching between the retrieval packaging ID, the item name, and the delivery destination (indicating the same information as the storage space ID).

When the search information is input, the information processor 66 searches for the storage/retrieval information 80 retrospectively in time series (step S102), and searches for information matching the search information (step S104). When there is no matching information, the process returns to the processing of step S100.

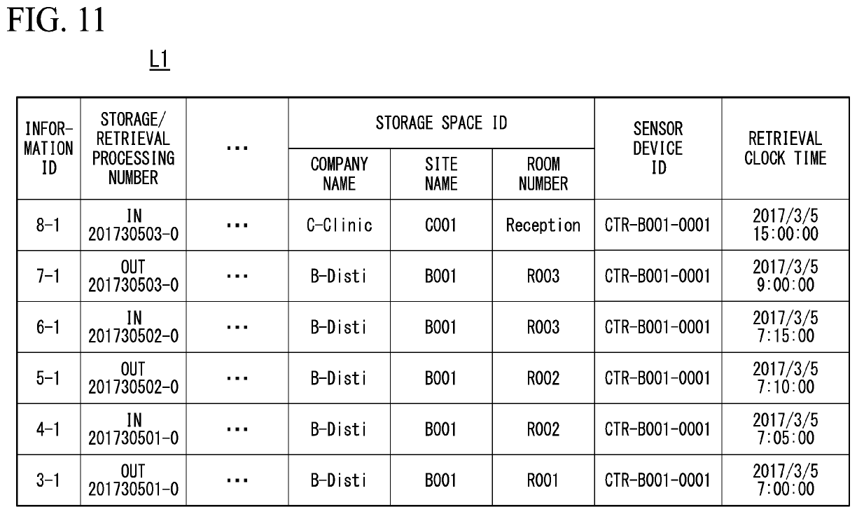

When there is matching information, the information processor 66 sets n=1, performs a search on the basis of the most recent pre-packaging ID (step S106) and generates a matching list retrospectively (step S108). FIG. 11 is a diagram showing an example of a matching list L1. The matching list L1 is a result of searching for storage/retrieval data having search conditions shown in FIG. 10, i.e., a combination of a storage packaging ID, an item name, and a storage space ID that is the same as a combination of a storage packaging ID (assumed to indicating the same information as the retrieval packaging ID in retrieval), an item name, and a delivery destination (indicating the same information as the storage space ID in retrieval) of a goods delivery time, retrospectively in time series.

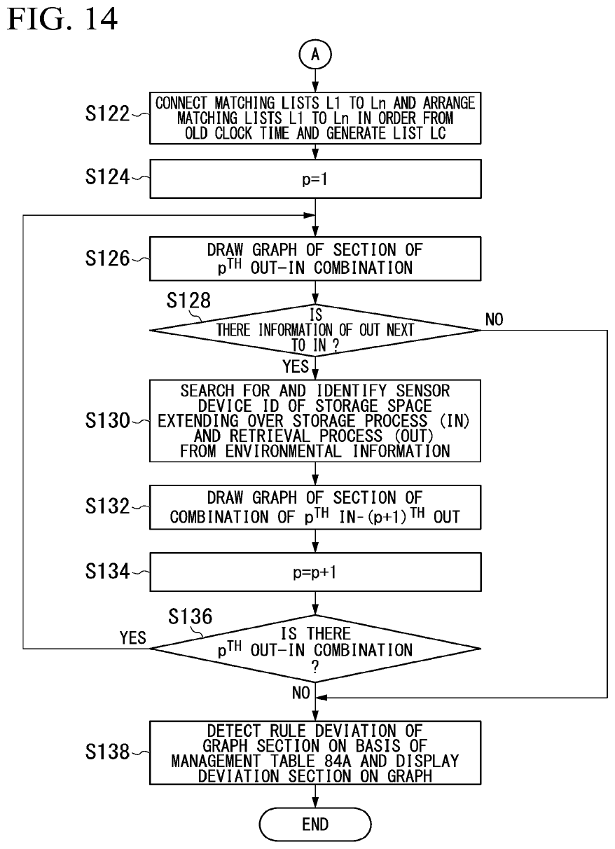

Next, the information processor 66 identifies the pre-packaging ID from the storage information and the retrieval information with the oldest clock time from the matching list (step S110). Next, the information processor 66 proceeds to the processing of step S122 of FIG. 14 when there is no pre-packaging ID and proceeds to the processing of step S114 when there is a pre-packaging ID.

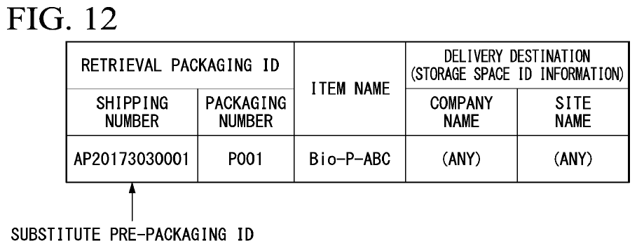

In step S114, the information processor 66 searches for storage information and retrieval information having a storage packaging ID or a retrieval packaging ID matching a pre-packaging ID identified in step S110 from the matching list retrospectively from the oldest clock time of the list generated in step S108. (step S116). FIG. 12 is a diagram showing an example of information used for a search. The storage/retrieval packaging ID used for the search is the pre-packaging ID of the information ID 3-1 that is the oldest storage/storage information of the matching list L1.

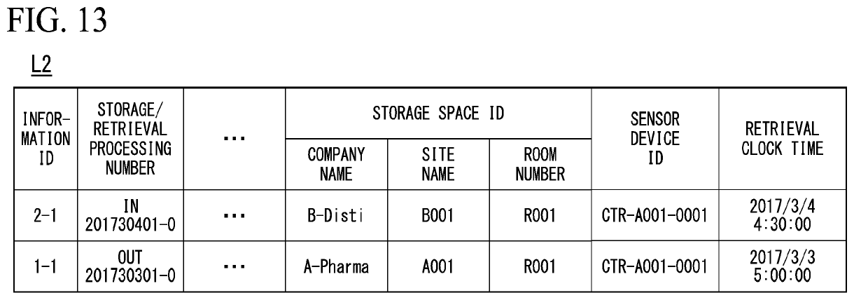

Next, when a search result indicates that there is no matching information, the information processor 66 proceeds to the processing of step S122 in FIG. 14. When there is matching information, the information processor 66 adds 1 to n (step S118), retrospectively generates a matching list (step S120), and proceeds to the processing of step S110. FIG. 13 is a diagram showing an example of a matching list L2 generated in step S120. The matching list L2 includes information ID 2-1 and information ID 1-1 as storage/retrieval information matching the search condition of FIG. 12.

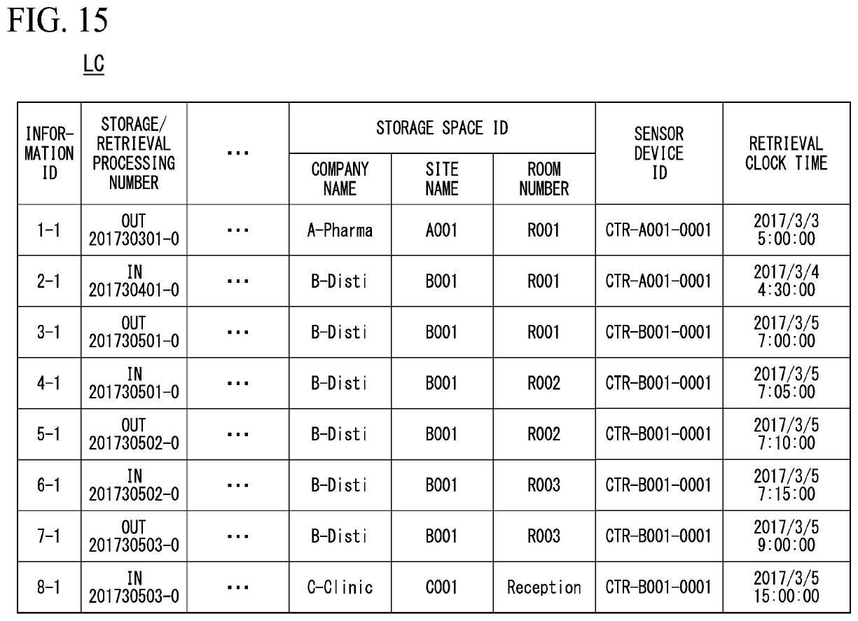

FIG. 14 is a flowchart (2) showing the flow of a process executed by the information processor 66. When there is no pre-packaging ID in step S112 or when there is no matching information in step S116, the information processor 66 integrates the generated matching lists 1 to n and arranges them in order from the oldest clock time (step S122). FIG. 15 is a diagram showing an example of a generated list LC generated by integrating the matching lists. The generated list LC is, for example, information in which information of information IDs of matching lists in FIG. 11 and FIG. 13 are connected together from the old clock time.

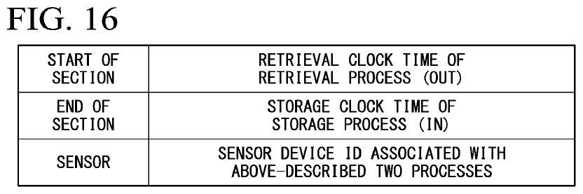

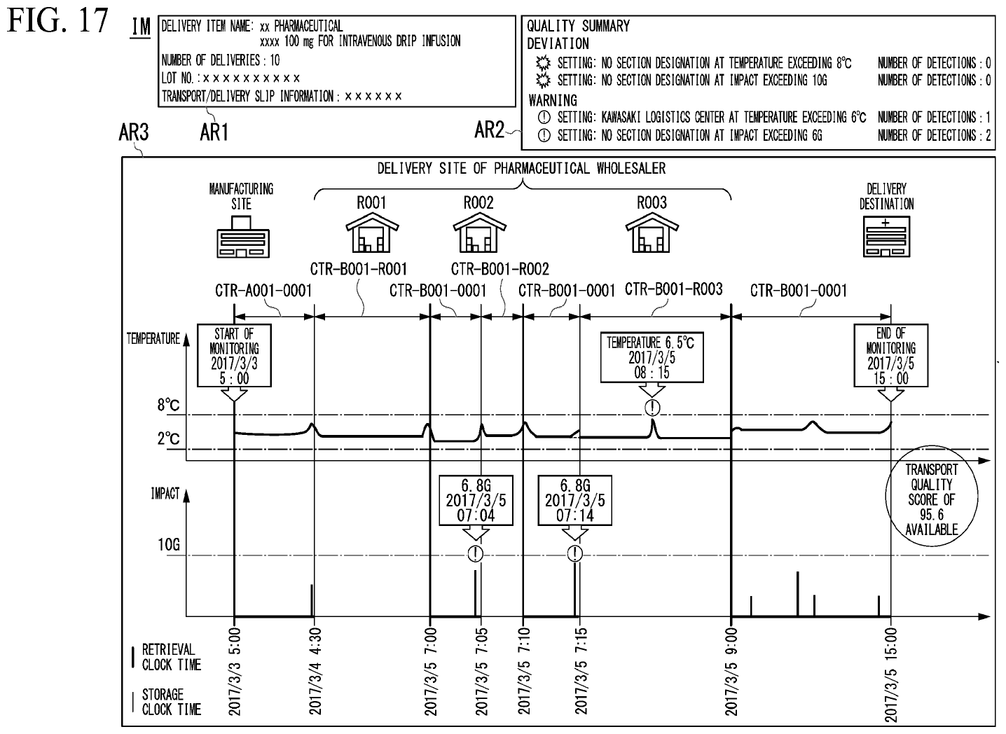

Next, the information processor 66 sets p=1 (step S124) and draws a section graph of a p^{th} OUT-IN combination (step S126). FIG. 16 is a diagram showing an example of a method of drawing a graph of a section of the p^{th} OUT-IN combination. The section graph is generated on the basis of information acquired by a sensor device ID associated with both the above-described storage and retrieval processes when a retrieval clock time of the retrieval process (OUT) is set as the start of the section and a storage clock time of the storage process (IN) is set as the end of the section. The section graph is a graph in which environmental information acquired by the first sensor device and the second sensor device is associated with a clock time (see FIG. 17 and an area AR3).

Next, the information processor 66 determines whether or not the information of the delivery process (OUT) next after the storage process (IN) is present (step S128). When there is no information about OUT next to IN, the process proceeds to the processing of step S138.

When there is information about OUT next to IN, the information processor 66 searches for and identifies a sensor device ID provided in a storage space extending over the storage process (IN) and the retrieval process (OUT) from the environmental information 82 (step S130) and draws a section graph of a combination of p^{th} storage information (IN)−(p+1)^{t}′ retrieval information (OUT) (step S132). This section graph is set by setting the storage clock time of the storage process (IN) as the start of the section and setting the retrieval clock time of the retrieval process (OUT) as the end of the section.

Next, the information processor 66 adds 1 to p (step S134), and determines whether or not there is a combination of p^{th} retrieval information (OUT)−p^{th} storage information (IN) (step S136). When there is a combination of p^{th} retrieval information (OUT)−p^{th} storage information (IN), the process returns to the processing of step S126. The information processor 66 iterates the above-described process to integrate the information acquired by the storage/retrieval information 80 and the sensor device ID, generate section environmental information, and cause the display device to display an image (for example, a section graph) based on the generated section environmental information. The integration means that environmental information acquired by one or more sensor devices that acquire environmental information of an environment where a prescribed cargo was placed and the storage/retrieval information 80 are associated and connected.

When there is no combination of p^{th} retrieval information (OUT)−storage information (IN), the information processor 66 detects a section where a value deviates from a standard value set in the section where the section graph is generated with reference to the management table 84A and causes the display device to display the detected section as a deviation section. Thereby, the process of one routine of the present flowchart ends.

FIG. 17 is a diagram showing an example of an image IM displayed on the display device. The image IM includes an area AR1 in which information about cargo is displayed, an area AR2 in which the number of times environmental information has exceeded or come close to a standard or a section the environmental information has exceeded or come close to a standard is displayed, and an area AR3 in which information indicating a detection result of a sensor device and a clock time in a process in which the cargo is transported is displayed. The area AR1 includes, for example, information such as an item name, the number of items, a lot No, and slip information. Transport/delivery slip information may include a retrieval packaging ID when the cargo was shipped from a delivery site or information associated with the retrieval packaging ID when the cargo was shipped from a delivery site. The area AR2, for example, includes information in which a standard relative to environmental information set for each section, the number of times the environmental information deviates from the set standard, and the number of times the environmental information comes close to the above-described standard although the environmental information does not deviate from the set standard are associated. These pieces of information are derived by the information processor 66.

The area AR3 includes information (a section graph) in which an associating relationship between the environmental information and a date and time or a section in a process from the shipping of the cargo (the start of monitoring) to the goods delivery to the delivery destination (the end of monitoring) is graphically shown. A transport quality score is displayed in the area AR3. The transport quality score is a score indicating the quality at the time of transport from the shipping of the cargo to the goods delivery to the delivery destination and is calculated as a larger value when a management state at the time of transport of the cargo is more suitable.

### [Score Calculation Process]

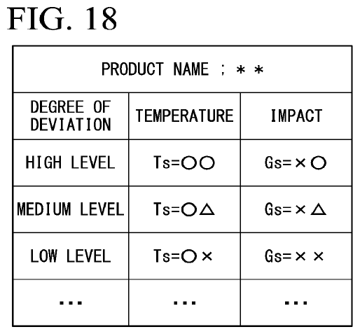

For example, the information processor 66 calculates a transport quality score on the basis of environmental information in a process from the shipping of cargo to the goods delivery to a delivery destination, the management table 84A, a score table 84C stored in the management information 84, and the following Eq. (1). FIG. 18 shows an example of the score table 84C. In the score table 84C, a coefficient Ts and a coefficient Gs are associated with a degree of deviation of an element included in the environmental information relative to a standard set in the management table 84A. The coefficient Ts is a coefficient associated with a degree of temperature deviation, and is a coefficient that becomes larger when the degree of deviation is larger. The coefficient Gs is a coefficient associated with a degree of impact deviation and is a coefficient that becomes larger when the degree of deviation is larger.

In the following Eq. (1), SC denotes a transport quality score, and s denotes time. For example, a value obtained by subtracting a value obtained by adding the coefficient Gs to a value obtained by multiplying the coefficient Ts by the time from 100 is the transport quality score. When the temperature or impact deviates from the set standard multiple times, a sum of values obtained by multiplying the coefficient Ts by the time or values obtained by adding the coefficient Gs associated with the degree of deviation of each time is subtracted from 100.

SC=100−{Σ(i=1,2, . . . u)(Ts(i)·s(i))+Σ(j=1,2, . . . v)Gs(j)} (1)

Here, u denotes the number of temperature deviations and v denotes the number of impact deviations.

The above-described method of calculating the transport quality score described above is an example and the transport quality score may be calculated based on other methods. For example, the transport quality score may be calculated based on the number of times the environmental information deviates from the set standard. Other environmental information elements may be used to calculate the transport quality score.

The information (hereinafter, a section environmental information report) included in the areas AR1 to AR3 shown in FIG. 17 described above may be generated automatically or may be generated by an instruction of the user. FIG. 19 shows an example of the mode setting table 84B stored in the management information 84. In the mode setting table 84B, storage space ID information in which the sensor device is installed and which includes a company name, a site name and a room number, information about an automatic report generation process, and information about a monitoring process are associated with the sensor device ID. The information about the automatic report generation process is information indicating whether a process of automatically generating the section environmental information report is in an on or off state. When the process of automatically generating the section environmental information report is set to the on state, the information processor 66 starts a process of automatically generating the section environmental information report when the logistics management device 60 acquires the environmental information from the sensor device. The information about the monitoring process is information indicating whether the monitoring process is in an on or off state and warning threshold value information. If the monitoring process is set to the on state, the information processor 66 automatically notifies the manager terminal device 100 or the packaging work/shipping management system 36, the delivery/goods delivery management system 38, and the like of information indicating that the environmental information deviates from the warning threshold value when the environmental information detected by the sensor device deviates from the set warning threshold value.

### Modified Examples of Flowchart

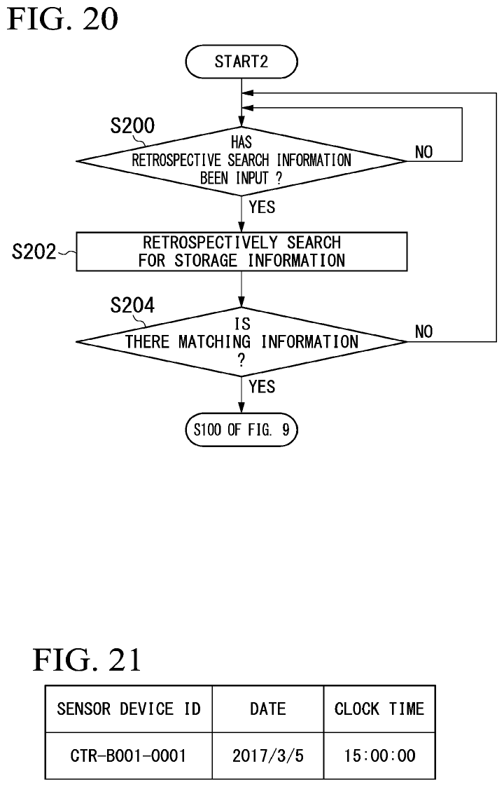

FIG. 20 is a flowchart of a modified example of the process executed by the information processor 66. First, the information processor 66 waits for retrospective search information to be input by the user or the like (step S200). FIG. 21 is a diagram showing an example of retrospective search information. The retrospective search information includes, for example, information of a sensor device ID, a date, and a clock time.

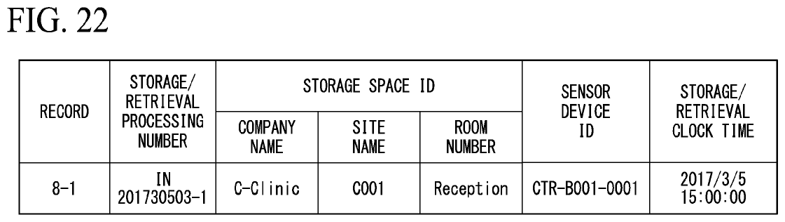

When the retrospective search information is input, the information processor 66 searches for information matching the retrospective search information from the storage/retrieval information 80 retrospectively in time series (step S202). That is, the storage/retrieval information whose sensor device ID matches the sensor device ID attribute in the information used for the retrospective search shown in FIG. 21 is searched for retrospectively from the date and the clock time shown in FIG. 21. In the present embodiment, information matching information of the information ID 8-1 is acquired as search information on the basis of the retrospective search information. FIG. 22 is a diagram showing an example of information acquired based on retrospective search information. As described above, the information processor 66 acquires search information from the retrospective search information. When there is matching information in step 204, the information processor 66 proceeds to the processing of step S100 of FIG. 9 described above. When there is no matching information, the process returns to the processing of step S200.

In this manner, because search information is acquired based on the sensor device ID and a date and time (a date and a clock time) input by the user and the process of the flowchart in FIG. 9 is executed based on the acquired information, the search of step S202 in FIG. 20 can be automatically executed from the ID of the sensor device and the environmental information acquisition date and time when the logistics management device 60 acquires environmental information from the sensor device and therefore user convenience is improved.

### [Processing of Learner and Determiner]

The learner acquires and stores information generated by the inside and the outside of the logistics system 1 and learns the stored information to derive a predicted transport quality score after scheduled delivery. The information stored by the learner 68 may include some or all of the storage/retrieval information 80, information of the management table 84A, the environmental information 82, the section environmental information generated by the information processor 66, the transport quality score generated by the information processor 66, and the quality (a result of a pharmaceutical efficacy check or the like) recognized at the delivery destination after the delivery of the cargo to the delivery destination given by the quality management system 40, and may further include information about a cargo transport route (delivery route information including positional information and the like may be added to the storage/retrieval information 80) and information about a climate when the cargo is transported.

The learner 68 executes machine learning on the basis of the acquired and stored information. Within the above-described acquired and stored information, the transport quality score generated by the information processor 66 and the quality (the result of the pharmaceutical efficacy check or the like) recognized at the delivery destination after the delivery of the cargo to the delivery destination given by the quality management system 40 can be used as teacher data for machine learning. If a route along which the cargo is transported is different, the time required for transport, the environment where the cargo is placed (for example, a temperature, humidity, an impact, or the like) will change, so that information of the route along which the cargo is transported becomes an element when the machine learning is performed. The learner 68 may execute a statistical process on the basis of the acquired information. The learner 68 updates a learning model internally generated and held by the learner 68 every time the teacher data is given, and the learner 68 operates when there is given data related to new cargo delivery other than the teacher data and the stored data such as scheduled cargo delivery route information or section environmental information generated by the information processor 66 at the time of shipping or goods delivery of the cargo and a predicted transport quality score of the new cargo delivery is updated.

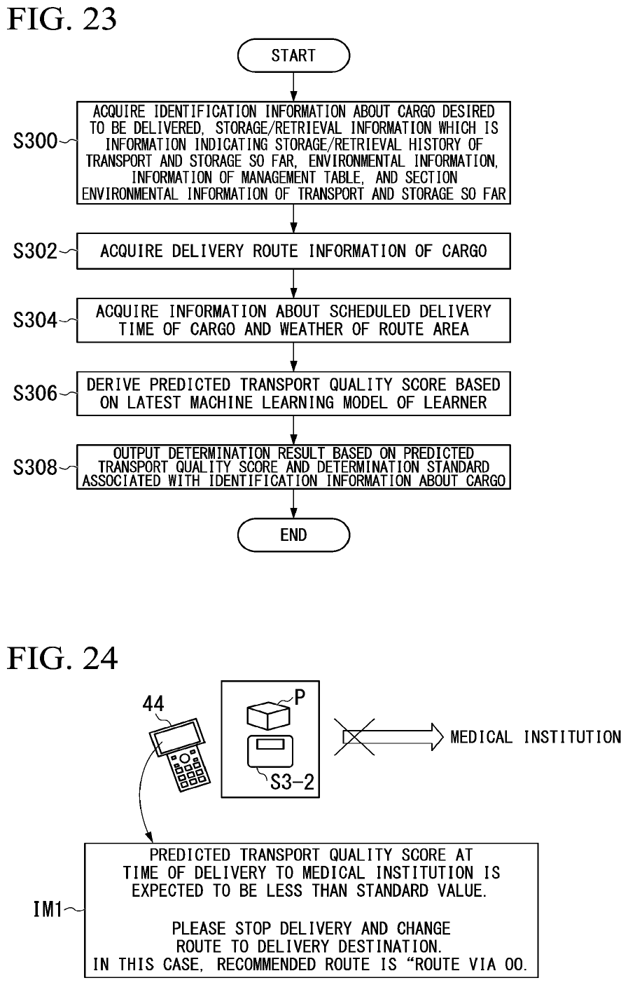

FIG. 23 is a flowchart showing an example of a flow of a process in the operation stage. The process of the present flowchart is executed when a process such as shipping or delivery of cargo is performed.

First, the learner 68 acquires identification information about cargo desired to be delivered, storage/retrieval information 80 which is information indicating a storage/retrieval history of transport and storage so far, environmental information 82, the information of the management table 84A, and section environmental information of transport and storage so far (step S300). Next, the learner 68 acquires scheduled cargo delivery route information (step S302). The information acquired in step S300 and step S302 is, for example, information acquired from the packaging work/shipping management system 36, the storage/retrieval information 80, the environmental information 82, the management table 84A, the information processor 66, and the delivery/goods delivery management system 38. Next, the learner 68 acquires information about the cargo scheduled delivery time and the weather of the route area (step S304). The information about this weather is a current weather condition and a predicted future weather condition.

Next, the learner 68 derives a predicted transport quality score when the cargo arrives at the delivery destination according to the latest machine learning model inside the learner 68 from the information acquired in steps S300 to S304 (step S306). Next, the determiner 70 determines whether or not the transport quality score derived by the learner 68 exceeds a preset standard and transmits a determination result to the packaging work/shipping management system 36, the delivery/goods delivery management system 38, or the manager terminal device 100 (step S308). The pre-set standard may be a standard determined between business operators, or may be a standard determined by a prescribed organization or institution. This predicted transport quality score is a score in which information about cargo or bundled cargo, a route from shipping of the cargo to a point on the way of delivery of the cargo, a route from a point on the way of delivery of the cargo to a delivery destination of the cargo, environmental information, and weather information on routes are reflected. Thereby, the process of the present flowchart ends.

FIG. 24 is a diagram showing an example of an image IM1 including a determination result of the determiner 70. The image IM1 is displayed, for example, on the display device of the packaging work/shipping management system 36, the delivery/goods delivery management system 38, or the manager terminal device 100. For example, at the delivery site before cargo P arrives at the delivery destination, the handy terminal 44 reads a bar code or the like attached to the cargo P and acquires information about the cargo. The learner 68 acquires environmental information on the basis of the information about the cargo. Then, the learner 68 derives a predicted transport quality score according to the acquired information and the latest learning model held inside the learner 68. If the predicted transport quality score is less than a preset standard, the determiner 70 causes the display device to display information indicating that the transport quality score is predicted to be less than a standard value when the cargo is delivered to the medical institution and information indicating that the delivery is stopped.

In this case, new route setting information from the present location of the cargo to the destination may be given from the delivery/goods delivery management system 38, the learner 68 may derive a predicted transport quality score when the cargo is transported along a given new route, and the determiner 70 may determine whether or not the new predicted transport quality score is less than the standard value and cause the display device to display a determination result. For example, as shown, the determiner 70 may cause the display device to display a recommended route whose transport quality score is greater than or equal to the standard value.

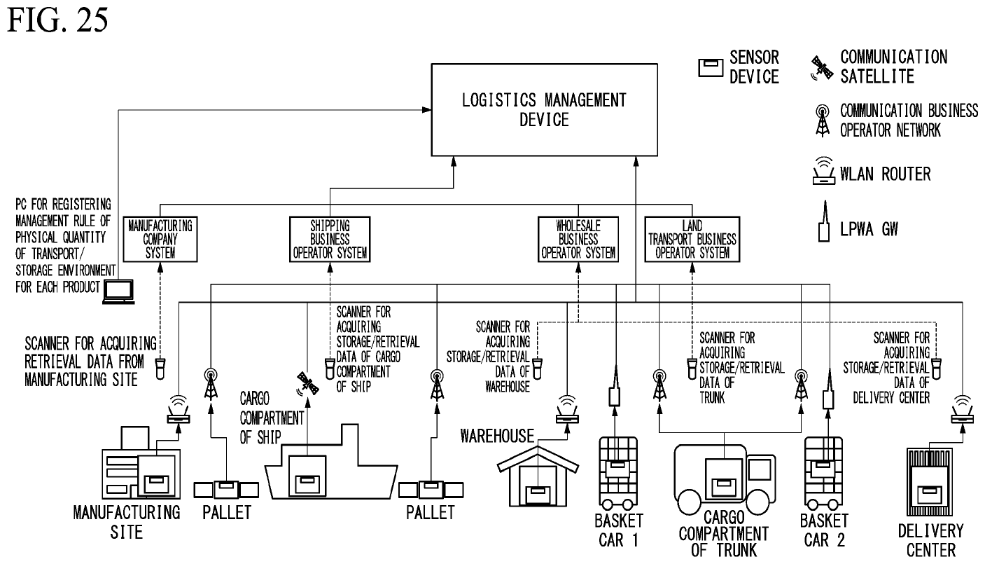

FIG. 25 is a diagram showing an example of a scene to which the logistics system 1 of the present embodiment is applied. As shown, the logistics management device 60 may communicate with a manufacturing company system managed by a manufacturing company, a shipping business operator system managed by a shipping company, a wholesale business operator system managed by a wholesaler, a land transport business managed by a land transport business, or the like and acquire the retrieval information or the storage information and the environmental information from each system.

For example, the manufacturing company system acquires retrieval information acquired by a scanner provided at a manufacturing site and a detection result of the sensor device provided at the manufacturing site, and transmits information acquired via a network of a wireless LAN to the logistics management device 60.

For example, the shipping business operator system regards a cargo compartment of a ship as the storage space and transmits storage information and retrieval information acquired by a scanner provided in the ship and detection results of sensor devices provided in the cargo compartment to the logistics management device 60 via a communication satellite.

For example, the land transport business operator system regards a cargo compartment of a truck as the storage space and transmits storage/retrieval information acquired by a scanner provided in the truck (or carried by a transport car) and detection results of sensor devices provided in the cargo compartment to the logistics management device 60 via a network managed by a communication business operator.

Each business operator system regards a sensor device provided on a pallet or a basket car as a sensor device bundled with cargo and transmits a detection result of the sensor device to the logistics management device 60 via a network of a communication business operator or a low power wide area (LPWA) network.

As described above, the sensor device is provided in the space where the cargo is placed and the logistics management device 60 can manage the quality of the cargo transported through various transport processes by acquiring the detection result of the sensor device, the storage information, and the retrieval information.

For example, the management of medicines and the like is necessary so that quality during transport or storage does not deteriorate. Thus, guidelines may be provided for the purpose of securing the quality of medicines in transport and storage. The guidelines are, for example, guidelines defined by good distribution practice (GDP) and pharmaceutical inspection convention and the pharmaceutical inspection co-operation scheme (PIC/S). In the present embodiment, even when cargo passes through a plurality of transport business operators or pass through a plurality of transport means, the logistics management device 60 can reliably acquire information for use in quality management of medicines for a transport time or a storage time from the shipping of medicines to the arrival at the delivery destination and more continuously monitor an environment in which the cargo is placed in a transport process.

Although a case in which medicines are transported has been described in the above-described example, the present embodiment is not limited to the medicines and may be applied when food, materials, and the like required to be managed on the basis of a prescribed standard are delivered.

According to at least one embodiment described above, there is provided an information acquirer (62, 64) configured to acquire identification information about cargo, identification information associated with a first sensor device for acquiring environmental information related to a storage location included in a section through which the cargo was transported, identification information about a second sensor device that moves along with the cargo, environmental information acquired by the first sensor device, environmental information acquired by the second sensor device, and history information obtained by performing a prescribed process on the cargo; and an information processor (66) configured to integrate the information acquired by the information acquirer and generate section environmental information indicating an environment in which the cargo was placed in the section through which the cargo was transported, so that it is possible to more continuously monitor an environment in which cargo is placed in a transport process.

While several embodiments of the present invention have been described, these embodiments have been presented by way of example only, and are not intended to limit the scope of the inventions. These embodiments may be embodied in a variety of other forms. Various omissions, substitutions and changes may be made without departing from the spirit of the inventions. The inventions described in the accompanying claims and their equivalents are intended to cover such embodiments or modifications as would fall within the scope and spirit of the inventions.

1. A logistics management device comprising:
an information acquirer configured to acquire identification information about cargo, identification information associated with a first sensor device for acquiring environmental information related to a storage location included in a section through which the cargo was transported, identification information about a second sensor device that is configured to move along with the cargo, environmental information acquired by the first sensor device, environmental information acquired by the second sensor device, and history information obtained by performing a prescribed process on the cargo; and
an information processor configured to integrate the information acquired by the information acquirer and generate section environmental information indicating an environment in which the cargo was placed in the section through which the cargo was transported.

2. The logistics management device according to claim 1, wherein the information acquirer includes:
a first information acquirer configured to acquire the identification information about the cargo, the identification information associated with the first sensor device, the identification information about the second sensor device, and the history information; and
a second information acquirer configured to acquire the environmental information acquired by the first sensor device and the environmental information acquired by the second sensor device.

3. The logistics management device according to claim 2, wherein the information processor is configured to generate information for causing the display device to display information indicating that the cargo deviates from a preset standard in association with the identification information about the cargo.

4. The logistics management device according to claim 1, wherein the information processor is configured to generate information for causing the display device to display an image based on the section environmental information.

5. The logistics management device according to claim 4, wherein the information processor is configured to determine whether or not the cargo deviates from a preset standard on the basis of the preset standard and the section environmental information generated by the information processor and includes a determination result in the image.

6. The logistics management device according to claim 1, further comprising a learner configured to learn a relationship between the section environmental information generated by the information processor, a preset standard, and quality of the cargo when the cargo has arrived at a destination.

7. The logistics management device according to claim 6, further comprising a determiner configured to determine whether or not the quality can be maintained so that the quality is greater than or equal to a set standard until the delivery of the cargo which is being delivered is completed on the basis of a learning result from the learner and the information acquired by the information acquirer.

8. A logistics management method comprising:
acquiring identification information about cargo, identification information associated with a first sensor device for acquiring environmental information related to a storage location included in a section through which the cargo was transported, identification information about a second sensor device that is configured to move along with the cargo, environmental information acquired by the first sensor device, environmental information acquired by the second sensor device, and history information obtained by performing a prescribed process on the cargo; and
integrating the acquired information and generating section environmental information indicating an environment in which the cargo was placed in the section through which the cargo was transported.

9. (canceled)

10. A non-transitory computer-readable storage medium that stores a computer program to be executed by a computer to perform at least:
acquire identification information about cargo, identification information associated with a first sensor device for acquiring environmental information related to a storage location included in a section through which the cargo was transported, identification information about a second sensor device that is configured to move along with the cargo, environmental information acquired by the first sensor device, environmental information acquired by the second sensor device, and history information obtained by performing a prescribed process on the cargo; and
integrate the acquired information and generate section environmental information indicating an environment in which the cargo was placed in the section through which the cargo was transported.
